(19) United States
(12) Patent Application Publication
(10) Pub. No.: US 2006/0076464 A1
(43) Pub. Date: Apr. 13, 2006

(54) Movable grooming apparatus and method therfor

(76) Inventor: Sandy Van, Las Vegas, NV (US)

Correspondence Address: NIKOLAI & MERSEREAU, P.A., 900 SECOND AVENUE SOUTH, SUITE 820, MINNEAPOLIS, MN, 55402, US

(21) Appl. No.: 10/959,881

(22) Filed: Oct. 7, 2004

(51) Int. Cl. F16M 11/00; A47F 5/00

(52) U.S. Cl. 248/122.1

(57) ABSTRACT

A grooming device positioning system includes a track and a grooming device holder movably coupled to the track for positioning a grooming device.

### FIELD OF THE INVENTION

This invention relates generally to grooming equipment, and more particularly, to stands adapted to hold grooming devices.

### DESCRIPTION OF THE RELATED ART

Numerous devices are available to satisfy personal grooming needs, including hair dryers, curling irons, brushes, curlers, hot irons, scissors, and similar devices. Many of these devices feature the common elements of requiring a close proximity to a person and also requiring a range of movement of the device to be used effectively. For example, effective use of a hair dryer requires positioning the hair dryer approximately one foot from a person's hair, and moving the hair dryer to target wet hair and to prevent damaging dry hair with excessive heat.

As a consequence, many grooming devices are designed to be hand-held so that a person may freely move and operate the devices during use. Unfortunately, problems arise when a person requires the use of multiple devices simultaneously. For example, a hair stylist may desire to operate a hair dryer, a comb, and a pair of scissors at the same time.

Various devices have been introduced to address this problem. For example, U.S. Pat. Nos. 6,199,805, 5,956,862, 5,737,847, 5,064,154, 4,809,444 and 4,278,223 each describe stationary hair dryer stands for hands-free drying. However, these devices share the problem of requiring people to either manually reposition the hair dryer or reposition themselves to ensure that their hair is dried and not damaged from prolonged exposure to the hot air.

UK Patent Application 9622124.7 introduces a wheeled base to a hair dryer stand. However, this device does not effectively address the problem that a user must either physically move to target the dryer onto a different portion of hair, or else manually reposition either the stand or the hair dryer, or both.

When grooming in front of a stationary mirror, it is not convenient for people to turn or move to accommodate the stationary hair dryer, as they may no longer be able to view their image in the mirror. Furthermore, having to repeatedly stop what they are doing in order to physically move the stand or reposition the hair dryer may become prohibitively strenuous and may also prevent the efficient completion of their grooming tasks. In addition, care must be taken when repositioning these devices. One needs to ensure that the hair dryer remains at an appropriate distance from the target hair or the benefits of using the hair dryer will be substantially reduced, and may even become injurious in the case of damaged hair.

A need therefore exists to provide a system and method that provides all of the advantages of the prior art with none of the disadvantages. The present invention satisfies these needs, and provides other, related, advantages.

### SUMMARY OF THE INVENTION

The foregoing objectives are achieved in the movable grooming device and method therefor.

In accordance with one embodiment of the present invention, a grooming device positioning system is disclosed. It includes a track for constraining a motion of the grooming device positioning system along the track, a grooming device holder movably coupled to the track so that the grooming device holder is positionable along the track.

In accordance with another embodiment of the present invention, a grooming device positioning system is disclosed that further includes a motor for moving the grooming device holder along the track.

In accordance with yet another embodiment of the present invention, a method of positioning a grooming device is disclosed. The method includes providing a track, coupling a grooming device to the track, and positioning the grooming device along the track.

The foregoing and other objects, features, and advantages of the invention will be apparent from the following more particular description of the preferred embodiment of the invention, as illustrated in the accompanying drawings.

### BRIEF DESCRIPTION OF THE DRAWINGS

FIG. 1 is an illustration depicting a perspective view of a grooming device positioning system used for home grooming in accordance with an embodiment of the present invention.

FIG. 2 is an illustration depicting a perspective view of a grooming device positioning system in accordance with another embodiment of the present invention.

FIG. 3 is an illustration depicting a perspective view of the grooming device positioning system of FIG. 1 used for salon grooming in accordance with an embodiment of the present invention.

FIG. 4 is an illustration depicting a perspective view of the track portion of a grooming device positioning system showing the motor attached to the track in accordance with yet another embodiment of the present invention.

### DESCRIPTION OF EMBODIMENTS OF THE INVENTION

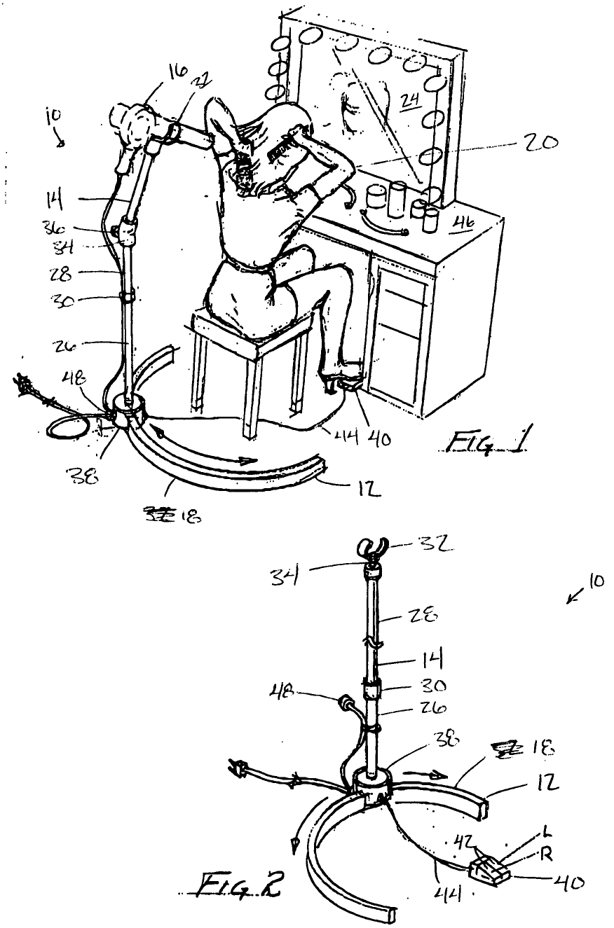

With reference now to the figures, and in particular to FIG. 1, the grooming device positioning system 10 is depicted in accordance with an embodiment of the present invention. It includes a track 12 for constraining a motion of the grooming device positioning system 10 along the track 12, and a grooming device holder 14 movably coupled to the track 12 so that the grooming device holder 14 is positionable along the track. Although the grooming device 16 depicted in FIG. 1 is an electric hair dryer, it should be understood to one skilled in the art that different types of grooming devices may be used without departing from the spirit and scope of the present invention. As one example, the grooming device 16 may be a mirror; other examples include but are not limited to, combs, brushes, scissors, or hairspray canisters. It is also within the spirit and scope of the present invention that more than one grooming device may be used with the present invention; for example, both a hair dryer and a mirror may be held by the grooming device holder 14.

As depicted in FIGS. 1-3, the grooming device holder 14 has a curved portion 32 dimensioned to engage the grooming device 16. However, one of ordinary skill in the art will recognize that various other structures may be used to engage the various grooming devices 16. For example, the use of clamps, hook and look material, magnetism, adhesives, threaded fasteners, or any other method of engaging a grooming device 16, or their equivalents, alone or in combination, are within the spirit and scope of the present invention.

Preferably the track 12 has a curved portion 18 substantially defining an arc. As shown in FIG. 1, the entire track 12 is curved to partially encircle a user 20 at the center of the arc. By positioning the grooming device holder 14 at various points along the track 12, the user 20 is able to locate and use the grooming device 16 at convenient, equidistant positions while keeping both hands free. Although in the present embodiment the track 12 has a curved portion 18, it should be understood that substantial benefits may be obtained by not having a curved portion 18 in the track 12, as long as the track 12 may be used to position a grooming device 16. Additionally, although FIG. 1 shows the track 12 located on the floor, it is within the spirit and scope of the present invention that the track 12 be located other than on the ground, such as suspended from the ceiling, elevated at waist- or head-height, or mounted to the surface of a wall, as examples.

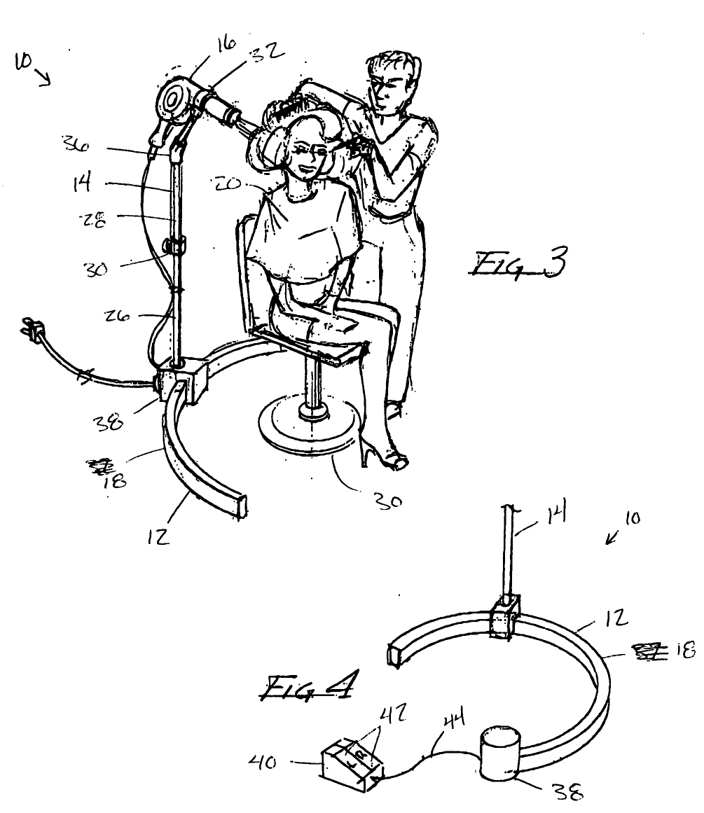

As illustrated in FIGS. 1-4, the grooming device holder 14 preferably positions a grooming device 16 towards a central position of the arc and the grooming device 16 remains substantially directed toward the central position of the arc when moved along the curved portion 18 of the track 12. As shown in FIGS. 1 and 3, a hair dryer so constrained will remain pointed toward a person proximate a central position of the arc described by the track 12, even as the grooming device holder 14 is slid from one position of the track 12 to another. However, it should be noted that certain benefits may be obtained by not having the grooming device holder 14 rotatably constrained. For example, the grooming device 16 being used may be a mirror used in conjunction with a stationary mirror 24 so that a user 20 may view a back portion of her head. In that case, the grooming device holder 14 of the present invention may freely pivot for manual alignment of the mirror, for example, or may incorporate a gearing mechanism (not shown) to rotate the grooming device holder 14 as it moves along the track 12 to automatically align the mirror, as another example.

It is preferred that the grooming device holder 14 is adjustable in height. Preferably, the grooming device holder 14 comprises a first portion 26 coupled to the track 12 and a second portion 28 slideably coupled to the first portion 26, so that a height of the grooming device holder is adjustable. FIGS. 1-3, illustrate one example of this operation by having a cylindrical first portion 26, into which the second portion 28 may be retracted or extended, and a threaded collar 30. The collar 30 may be released for adjusting the height and tightened to maintain the current height. It will be apparent to one skilled in the art that other methods may be employed: for example, by providing a spring-biased protrusion (not shown) on the second portion 28 to engage a series of spaced-apart holes (not shown) in the first portion. The height being adjusted by compressing the protrusion, adjusting the height, and allowing the protrusion to engage another hole at the desired height. As another example, an electrical motor 38 may be used to extend or retract the second portion 28. It should also be clearly understood that certain benefits may be obtained by not having the height of the grooming device holder 14 be adjustable, so long as the height is beneficial for using the grooming device 16. For example, as depicted in FIG. 3, if the present invention 10 is used in a professional salon having adjustable-height chairs 30, the chair 30 may be raised or lowered to an appropriate height for using the grooming device 16.

Preferably, the grooming device holder 14 comprises means for orienting a grooming device 16 relative to the grooming device holder 14. For example, the grooming device holder 14 may have a pivoting portion or ball joint 34 restrained by a locking device 36 as shown in FIG. 1. As a second example, the grooming device holder 14 may have a pivotable portion 34 that is held in place by friction as shown in FIG. 2. Yet another example is a flexible gooseneck portion 36 as shown in FIG. 3. As yet another example, an electrical motor (such as motor 38) may be used to orient the grooming device 16. It will be understood by one of ordinary skill that other methods of orienting a grooming device 16 relative to the grooming device holder 14 may be employed without departing from the spirit and scope of the present invention. It should also be understood that certain benefits may be obtained by not providing means for orienting a grooming device 16, as long as the grooming device 16 may be used for grooming purposes.

In accordance with another embodiment of the present invention 10, the movable grooming device system comprises a motor 38 for moving the grooming device holder 14 along the track 12. The motor 38 allows the user 20 to reposition the grooming device holder 14 efficiently and with minimal interruption of grooming activities. Although it is preferred that the motor 38 is an electric motor for quiet and clean operation, it is within the spirit and scope of the present invention that any type of motor 38 may be used, as long as the motor 38 is capable of moving the grooming device holder 14 along the track 12.

Preferably, a control device 40 is coupled to the motor 38 for controlling an operation of the motor 38, where a first actuation of the control device 40 moves the grooming device holder 14 a first direction along the track 12, and where a second actuation of the control device 40 moves the grooming device holder 14 a second direction along the track 12. The control device 40 preferably comprises a foot pedal 42, so that the grooming device holder 14 is positionable along the track 12 by stepping on the foot pedal 42. FIG. 4 shows the control device 40 having two foot pedals 42, one to provide a leftward motion and the other to provide rightward motion along the track 12. However, additional pedals or controls may be desirable to perform other functions, such oscillatory movement along the track 12, or to raise or lower the grooming device 16, or to orient the grooming device 16 relative to the grooming device holder 14.

Although the control device 40 is depicted in FIGS. 1, 2 and 4 as having a foot pedal 42 coupled to the motor 38 via a electrical wire 44, it is within the spirit and scope of the present invention that the control device 40 may be coupled to the motor 38 by any other suitable means, including mechanical coupling and wireless coupling. Furthermore, it should be understood that certain benefits may be obtained by not having the control device 40 comprise a foot pedal 42, as long as the control device 40 may be used to control an operation of the motor 38. For example, the control device 40 may be held in the user's hand, worn on a wrist, or fastened to a surface such as a counter 46 or mirror 24, and feature finger-operated controls such as buttons or rocker switches. As another example, the control device 40 may be voice-operated and feature a microphone, processor and memory for executing voice recognition software to process user commands.

In accordance with one embodiment of the present invention, the motor 38 is movably coupled to the track 12, and the grooming device holder 14 is attached to the motor 38, as depicted in FIGS. 1-3. It will be understood by one of ordinary skill that various mechanisms may be used to move the motor 38 along the track 12 without departing from the spirit and scope of the present invention: for example, wheels, gears, or cables (not shown) may be operated by the motor to provide movement along the track.

Another embodiment of the present invention is shown in FIG. 4, where the motor 38 is rigidly coupled to the track 12. It will be understood by one of ordinary skill in the art that various mechanism may be employed so that the motor 38 controls the movement of the grooming device holder 14 along the track 12 without departing from the spirit and scope of the present invention. For example, the grooming device holder 14 may be coupled to a cable, belt, or chain (not shown) extending the length of the track and rotated by the motor 38. As another example, the motor 38 may drive a plurality of wheels along the track (not shown) to propel the grooming device holder 14. As yet another example, magnetic levitation and propulsion may be used.

Preferably, the grooming device positioning system 10 further comprises an electrical outlet 48 for providing electrical power to a grooming device 16, as depicted in FIGS. 1 and 2. Because the grooming device 16 may undergo a wide range of motion during use, extending a cord from a wall outlet directly to the grooming device 16 may be unsafe or impractical. Multiple outlets 48 may be provided if multiple electrical grooming devices 16 are used. However, it should be understood that certain benefits may be obtained by the grooming device positioning system 10 not comprising an electrical outlet 48, as long as a grooming device 16 is capable of proper use. For example, a non-electrical grooming device 16 would not benefit from having an electrical outlet 48.

### STATEMENT OF OPERATION

In accordance with an embodiment of the present invention, a method of positioning a grooming device 16 is disclosed. The method includes the steps of providing a track 12, coupling a grooming device 16 to the track 12, and positioning the grooming device 16 along the track 12.

In accordance with another embodiment, the method of the present invention preferably further includes providing an adjustable-height grooming device holder 14. The grooming device holder 14 has a first portion 26 coupled to the track and has a second portion 28 coupled to the grooming device 16. The method of the present embodiment includes adjusting the height of said grooming device holder by repositioning the first portion 26 relative to the second portion 28.

In accordance with another embodiment, the method of the present invention preferably further includes providing a grooming device holder 14 having means for orienting a grooming device 16 relative to the grooming device holder 14. The method of the present embodiment includes adjusting the orientation of the grooming device 16.

In accordance with yet another embodiment, the method includes the step of providing a motor 38 to automate the positioning. The positioning along the track 12 is performed by controlling an operation of the motor 38. Preferably, a foot pedal 42 is provided for controlling an operation of the motor 38, so that the positioning is performed by actuating the foot pedal 42.

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. A grooming device positioning system, comprising, in combination:
a track;
a grooming device holder movably coupled to said track so said grooming device holder is positionable along said track; and
a motor for moving said grooming device holder along said track.

2. The system of claim 1, further comprising a control device coupled to said motor for controlling an operation of said motor, wherein a first actuation of said control device moves said grooming device holder a first direction along said track, and wherein a second actuation of said control device moves said grooming device holder a second direction along said track.

3. The system of claim 2, wherein said control device comprises a foot pedal.

4. The system of claim 1, wherein said track having a curved portion substantially defining an arc.

5. The system of claim 4, wherein said grooming device holder positions a grooming device towards a central position of said arc, said grooming device remains substantially directed toward said central position of said arc when moved along said curved portion of said track.

6. The system of claim 1, further comprising an electrical outlet for providing electrical power to a grooming device.

7. The system of claim 1, wherein said motor is movably coupled to said track, and wherein said grooming device holder is attached to said motor.

8. The system of claim 1, wherein said motor is rigidly coupled to said track.

9. The system of claim 1, wherein said grooming device holder is adjustable in height.

10. The system of claim 1, wherein said grooming device holder comprises means for orienting a grooming device relative to said grooming device holder.

11. A grooming device positioning system, comprising, in combination:
a track; and
a grooming device holder movably coupled to said track so said grooming device holder is positionable along said track.

12. The system of claim 11 wherein said track having a curved portion substantially defining an arc.

13. The system of claim 12, wherein said grooming device holder positions a grooming device towards a central position of said arc, said grooming device remains substantially directed toward said central position of said arc when moved along said curved portion of said track.

14. The system of claim 11, wherein said grooming device holder is adjustable in height.

15. The system of claim 11 wherein said grooming device holder comprises means for orienting a grooming device relative to said grooming device holder.

16. A method of positioning a grooming device, comprising the steps of:
providing a track;
coupling a grooming device to said track; and
positioning said grooming device along said track.

17. The method of claim 16, further comprising the steps of:
providing an adjustable-height grooming device holder, said grooming device holder having a first portion coupled to said track and having a second portion coupled to said grooming device; and
adjusting the height of said grooming device holder.

18. The method of claim 16, further comprising the steps of:
providing a grooming device holder having means for orienting a grooming device relative to said grooming device holder; and
adjusting the orientation of said grooming device.

19. The method of claim 16, further comprising the step of providing a motor to automate said positioning, and wherein said positioning along said track is performed by controlling an operation of said motor.

20. The method of claim 19, further comprising the step of providing a foot pedal for controlling an operation of said motor, and wherein said positioning is performed by actuating said foot pedal.
